(19) United States
(12) Patent Application Publication
(10) Pub. No.: US 2002/0029351 A1
(43) Pub. Date: Mar. 7, 2002

(54) Method for controlling the termination date of electrical documents

(76) Inventor: Jyh-Yuan Deng, Shu-Lin City (TW)

Correspondence Address: WINSTON HSU, SF. 389, FU-HO ROAD, YUNGHO CITY, TAIPEI, TW

(21) Appl. No.: 09/740,899

(22) Filed: Dec. 21, 2000

(30) Foreign Application Priority Data
Sep. 1, 2000 (TW) 89117916

(51) Int. Cl. H04L 9/32

(52) U.S. Cl. 713/201

(57) ABSTRACT

A method used in networks for controlling the termination date of electrical documents. The network includes a server connected with a plurality of terminals, that can request the server to rent an electrical document for a specific time period and the server storing the electrical document to a storage device of the terminal. Users begin by loading an application program in the terminal to set a specific storing position for the electrical document. Then, the server encrypts the current date, the termination date, and the plaintext of the electrical document to a corresponding ciphertext, and transferring the ciphertext to the terminal. The terminal accepts and stores the ciphertext in the specific storing position of the storage device, and records the information of the storing position when it requests the server to rent the electrical document. When users intend to read an electrical document, the application program matches the current storing position with the recorded storing position and deciphers the ciphertext to the original ciphertext of the electrical document. The application program continually updates and stores the current date in the storing position during the time users read the electrical document. When the current date exceeds the termination date or when the total reading hours exceeds a predetermined reading hours, the application program denies access to the electrical document.

### BACKGROUND OF THE INVENTION

1. Field of the invention

The present invention relates to a method for controlling the termination date of electrical documents, and more particularly, to a method for downloading electrical documents from the internet to a reading device and denying access to the electrical documents if the current date has exceeded the termination date.

2. Description of prior art

Due to rapid advances in internet technology, information can be exchanged between all parts of the world both quickly and easily. In the past, to purchase a book, one had to personally go to a bookstore whereas nowadays, one only needs to sit in the comfort of one's own home and search for and order the desired book over the internet.

However, the more books purchased, the more space required for their storage. Thus, digitizing the contents of a book into the form of an electrical document is proposed to solve the above-mentioned problem. With little effort, a consumer can rent the desired electrical document for a specified time period and download it from the internet to his or her computer to be read. Reading information on paper is still the norm, but consumers are slowly adjusting to reading digitized information. However, a difficult problem occurs for copyrighters since nothing prevents the copying or transmittance of the electrical documents without legal permission. As well, no method prevents the deliberate changing of the termination date of an electrical document to gain an unspecified reading period.

It is an object of the present invention to provide a method for preventing electrical documents, downloaded from the internet to reading devices, from being copied or transmitted without legal permission. The other objective of the present invention is to provide a date examination strategy to deny access to an electrical document if the current date has exceeded the termination date.

In accordance with the claimed invention, a method used in networks for controlling the termination date of electrical documents, and includes a server connected with a plurality of terminals that can request the server to rent an electrical document for a specific period of time, and the server storing the electrical document to a storage device of the terminal.

It is an advantage of the present invention that a method is used to prevent electrical documents from being copied or transmitted without permission to allow for proper copyright protection.

These and other objectives of the present invention will no doubt become obvious to those of ordinary skill in the art after reading the following detailed description of the preferred embodiment which is illustrated in the various figures and drawings.

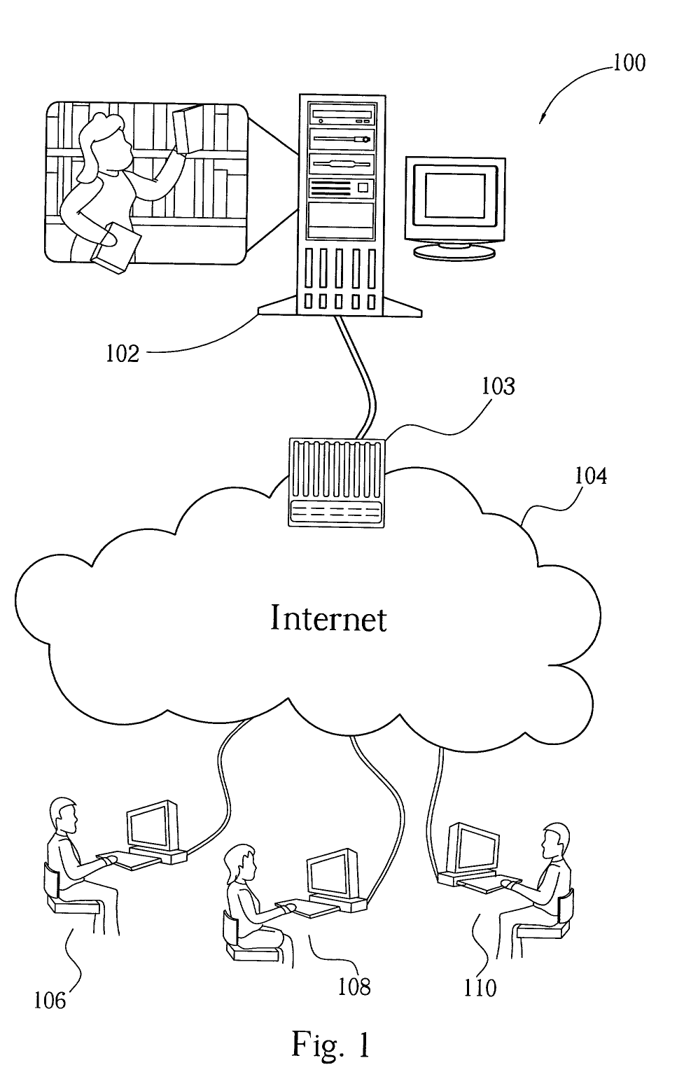

FIG. 1 is a schematic diagram of networks of the present invention for controlling the termination date of electrical documents.

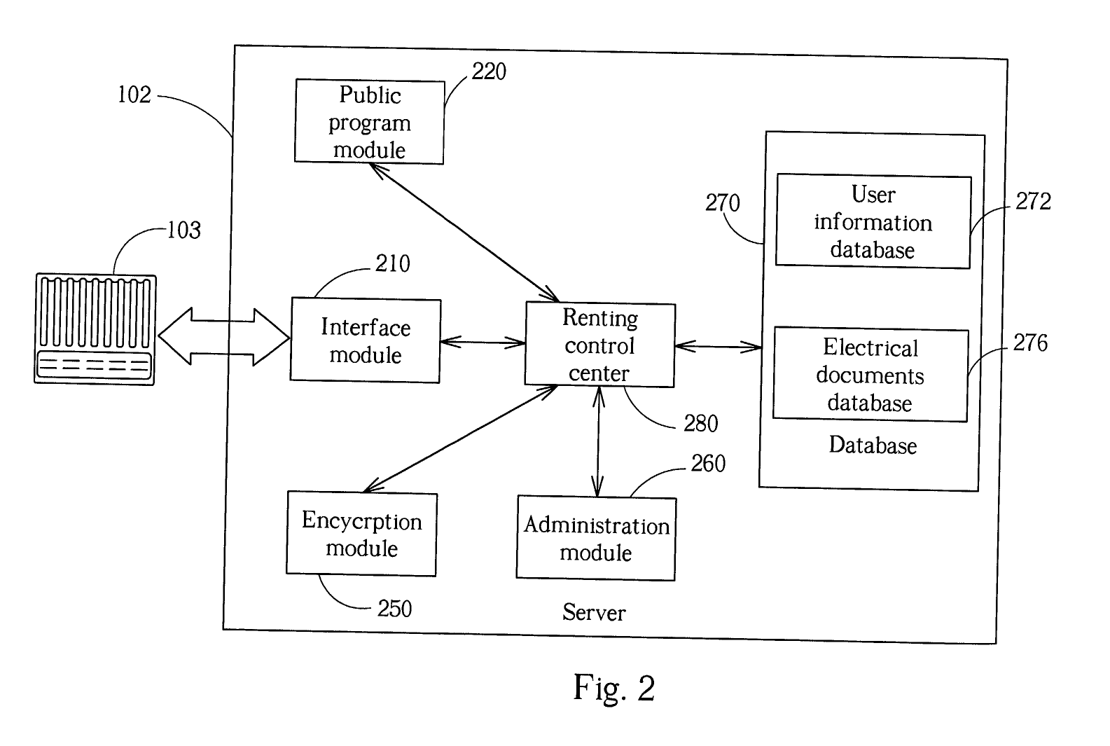

FIG. 2 is a function block diagram of the server of the present invention networks.

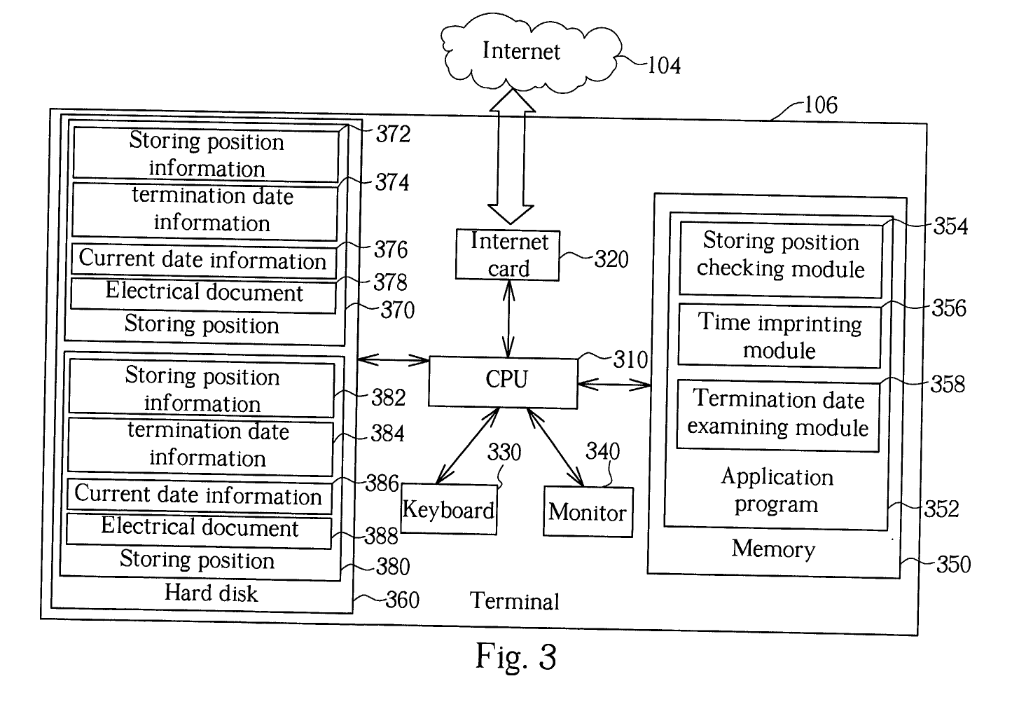

FIG. 3 is a function block diagram of the terminal of the present invention networks.

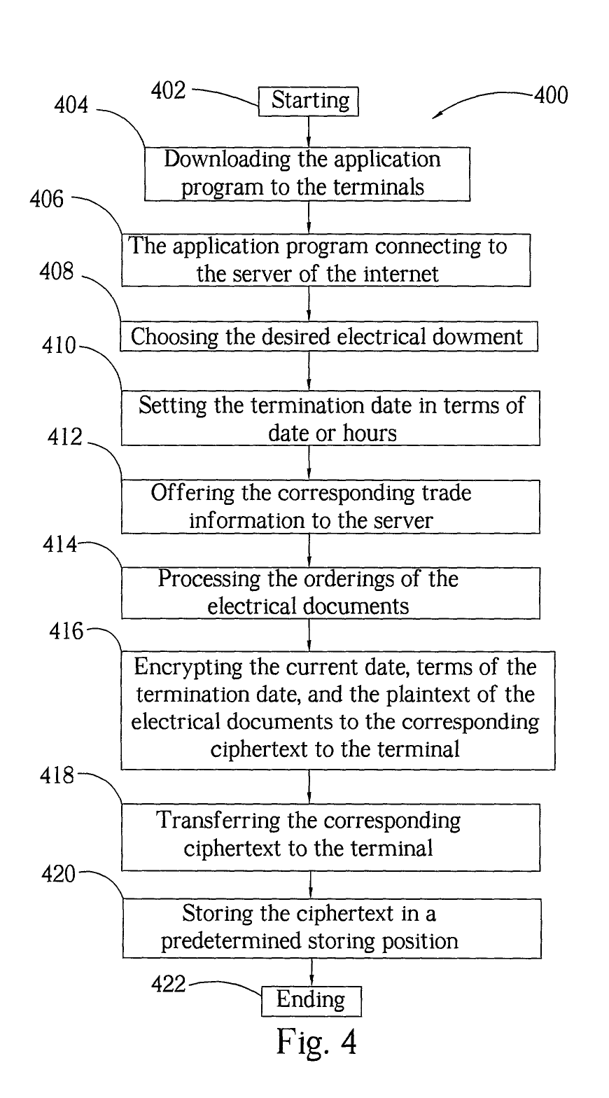

FIG. 4 is a flow chart of the process of renting electrical documents from the server of the present invention networks.

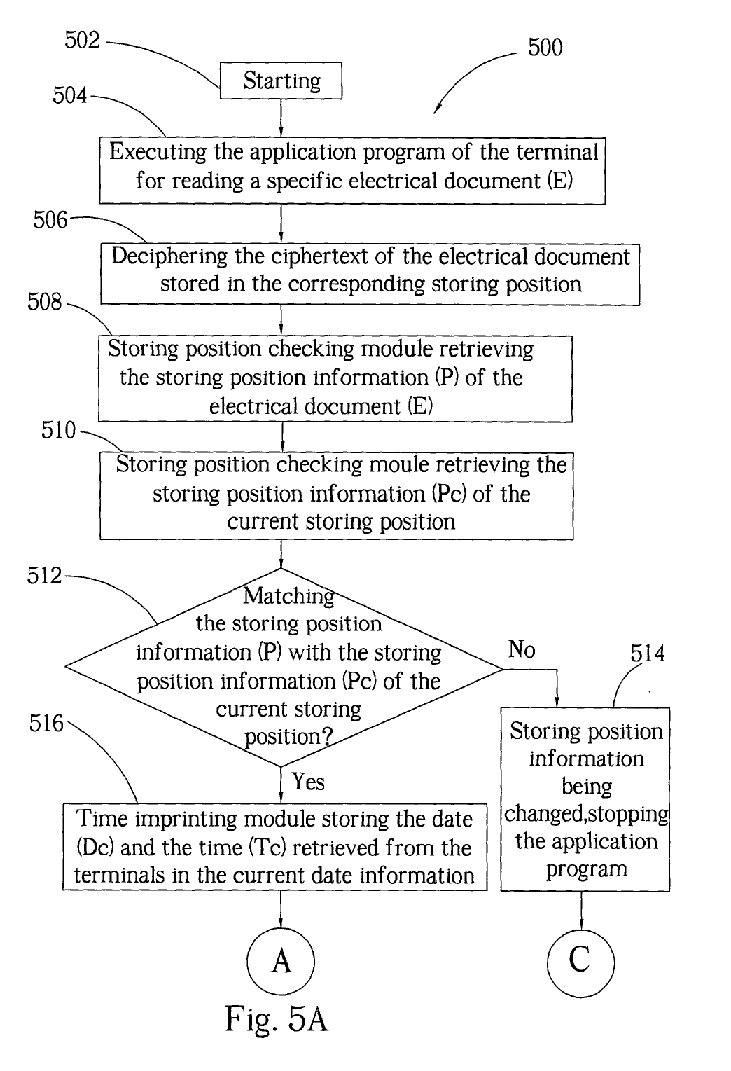

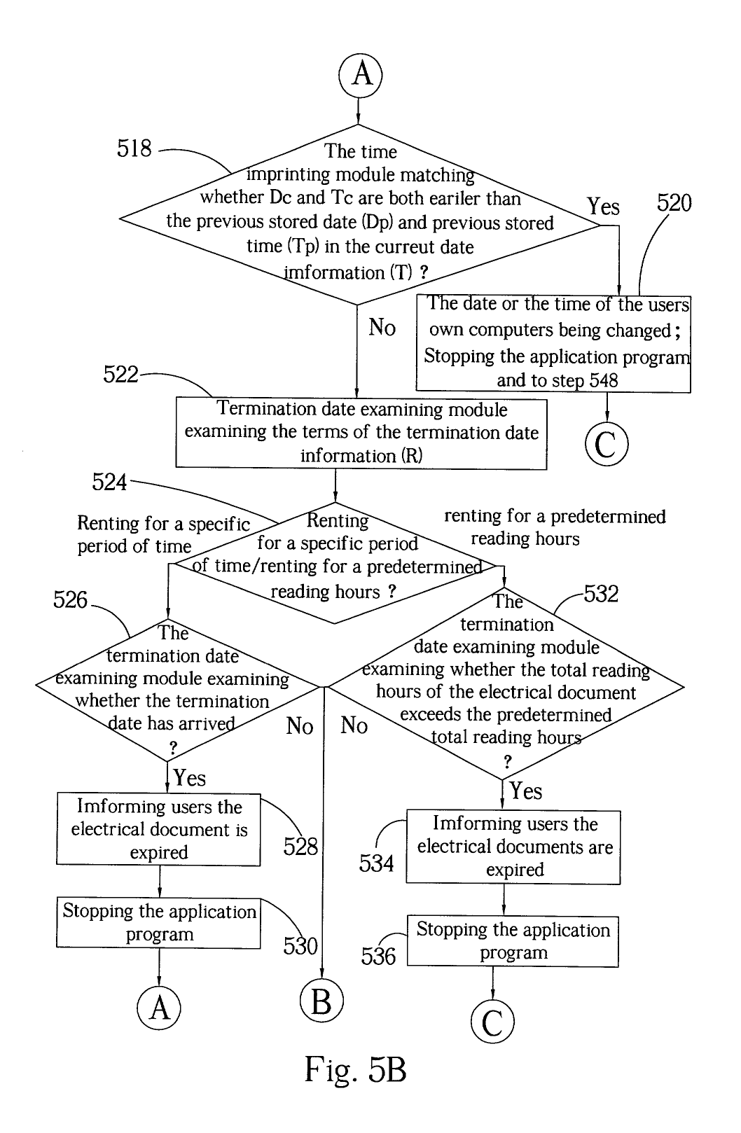

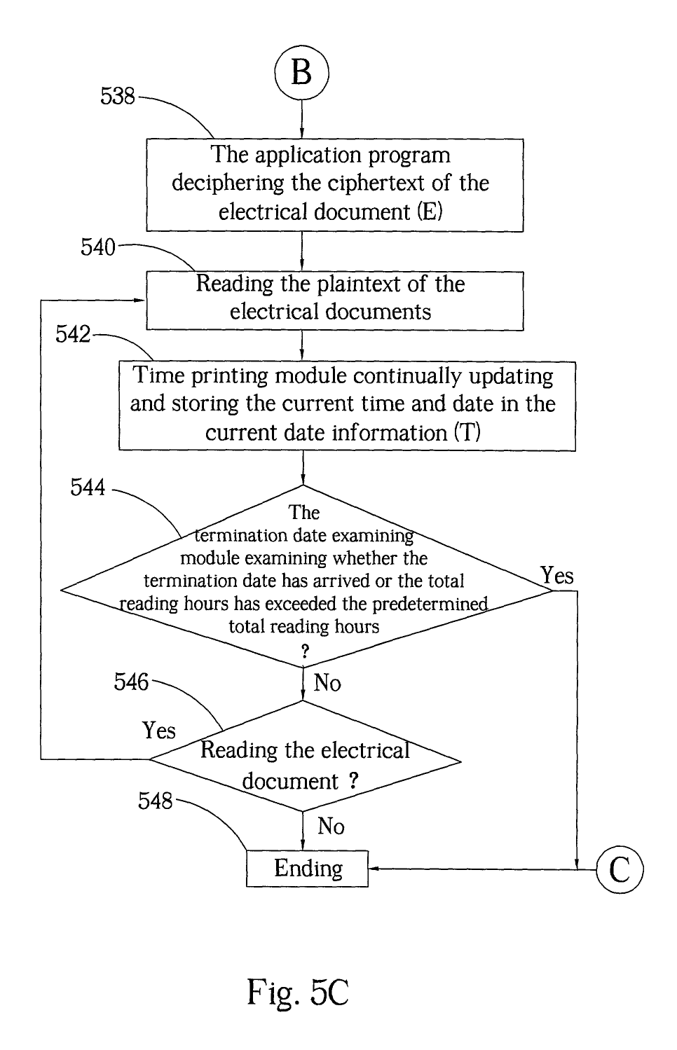

FIGS. 5A, B and C are flow charts of the process of reading electrical documents of the present invention networks.

Please refer to FIG. 1 of a schematic diagram of networks 100, for controlling the termination date of electrical documents, of the present invention. The networks 100 include a server 102 connected to the internet 104 via a firewall 103, and a plurality of terminals 106, 108 and 110 connected to the internet 104. The firewall 103 filters packages from the internet 104 and allows certain registered internet services like telnet, e-mail, or FTP to connect to the internet 104, and ensures both the configuration and information of the server 102 do not become hacked. Each terminal 106, 108 and 110 can be a desktop computer, notebook computer, PDA or any other device capable of connecting to the internet 104.

Please refer to FIG. 2 of a function block diagram of the server 102 of the present invention networks 100. The server 102 includes an interface module 210, a public programs module 220, an encryption module 250, an administration module 260, a database 270 and a renting control center 280.

The interface module 210 of the server 102, connected to the firewall 103, exchanges information with the internet 104 and conducts appropriate information conversions when required. The public programs module 220 stores every kind of public program open to users as controlled by the server 102, for example, an application program allowing a user to register, download, and read electrical documents. The encryption module 250 is used to encrypt the plaintext of the electrical documents which can be later sent to users after completing the procedures of renting electrical documents. The administration module 260 is used to process the orderings of the electrical documents. The database 270 includes at least two sub databases, a user information database 272 and an electrical document database 276.

The user information database 272 stores user information while the electrical document database 276 stores the plaintext of the electrical documents, all having their own document codes for identification or query. The renting control center 280 is used to control the server 102 and all its modules or databases, as well as the information flowing between them.

Please refer to FIG. 3 of a function block diagram of the terminals 106 of the present invention networks 100. The terminals 106, which can be PCs or PDAs, include CPUs 310, storage devices like memory 350 and hard disks 360, the internet cards 320, input devices like keyboards 330, and output devices like monitors 340 respectively. To exchange information with the server 102, the terminals 106 have to download an application program 352, which allows users to register, download, and read electrical documents from the public program module 220 of the server 102, or the internet 104. The application program 352 is stored in the hard disk 360 of the terminals 106. When users execute the application program 352, it is loaded to the memory 350 and executed by the CPUs 310. The application program 352 includes at least three program modules like a storing position checking module 354, a time imprinting module 356 and a termination date checking module 358, all able to be downloaded by the users at any given time.

Before renting electrical documents from the server 102, users have to download the application program 352 from the internet 104 and the application program 352 will set a specific storing position 370, like a specific track or a specific sector, for the electrical documents. The position information 372 of the specific storing position 370 is recorded for subsequent storing position examination. When users execute the application program 352 of the terminals 106, it searches the electrical documents desired by the users on the internet 104, and sets the termination date of the documents in terms of days or hours. The application program 352 denies access to the electrical documents when total reading hours exceed predetermined reading hours or when the current date has exceeded the termination date.

The administration module 260 of the server 102 processes the orderings of the electrical documents to verify which electrical documents will be rented as well as the exact termination date. After verifying the contents of the orderings of the electrical documents, the renting control center 280 (of FIG. 2) encrypts the current date, the termination date, and the plaintext of the electrical documents to a corresponding ciphertext and transfers the ciphertext to the terminals 106. After receiving the ciphertext, the application program 352 of the terminals 106 stores the ciphertext in the specific storing position 370 of the hard disk 360.

The position information 372, a termination date information 374, a current time information 376 and the electrical documents 378 are stored in the specific position 370. The termination date information 374 describes the condition of the termination date whether it be by date or hours, and the current time information 376 records the time the renting control center 280 accepts the orderings of the electrical documents. The position information 372 functions to record the storing position of the hard disk 360 of the electrical documents. If users rent another electrical document 388, the application program 352 sets another specific storing position 380 of the hard disk 360 in the same previous manner. The application program 352 stores the content, the termination date information 384, and the current date information 386 of the electrical document 388 in the specific storing position 380. The position information 382 functions to record the storing position 380 of the electrical document 388. Since the information stored in the specific storing position 370 or 380 is encrypted, users intending to read the electrical document must designate the encryption to a corresponding electrical document.

Please refer to FIG. 4 of a flow chart 400 of renting electrical documents from the server 102 of the present invention networks 100.

Step 402: starting;

Step 404: downloading the application program 352 to the terminal 106;

Step 406: the application program 352 of the terminal 106 connecting to the server 102 of the internet 104;

Step 408: choosing the desired electrical documents;

Step 410: user choosing the termination date in terms of date or hours;

Step 412: user offering the corresponding trade information, for example, credit card numbers, titles of the desired electrical documents or terms of the termination date, etc. to the server 102;

Step 414: the administration module 260 processing the orderings of the electrical documents;

Step 416: encrypting the current date, terms of the termination date or plaintext of the electrical documents to the corresponding ciphertext;

Step 418: the server 102 transferring the corresponding ciphertext to the terminal 106;

Step 420: the application program 352 of the terminal 106 storing the ciphertext in a predetermined storing position 370 of the hard disk 360;

Step 422: ending;

When users intend to read an electrical document, the application program 352 determines whether the current storing position and the recorded storing position 370 match. More specifically, the storing position checking module 354 matches whether the recorded position information 372 is the same as the current storing position to prevent unauthorized changes in the contents of the electrical document. If the termination date 374 or the current date information 376 of an electrical document is changed, difficulty occurs in storing the change in the original storing position whereby hacking of the encrypted electrical document is detected to stop the deciphering of the ciphertext of the electrical document 378. If the current storing position of the electrical document matches the recorded storing position 372, hacking of the encrypted electrical document is not detected, and the application program 352 deciphers the ciphertext of the electrical document 378.

The two conditions, date or hours, of the termination date for users, allow the termination date checking module 358 to judge the expiration of electrical documents. When users start reading the contents of the electrical documents, the application program 352 begins recording. More specifically, the termination date examining module 358 attaches the total reading hours information to the termination date information 374 of the storing position 374. The time imprinting module 356 of the application program 352 continually updates and stores the current date in the current time information 376 of the storing position 370. Every time users start reading the electrical documents, the termination date examining module 358 examines the termination date information 374 and the current time information 376 recorded in the storing position 370.

When the current date has exceeded the termination date or when the total reading hours exceeds a predetermined reading hours, the application program 352 informs users the electrical document is expired and denies its access.

As well, the time imprinting module 356 of the application program 352 updates and stores the current date in the storing position during the time users read the electrical documents as a way to prevent users from changing the time on their own computers in order to read for a longer time period. Every time users execute the application program 352 for reading the electrical documents, the termination date examining module 358 examines the termination date information 374 of the storing position 370 to verify that the time of the users' own computers has not exceeded the termination date, and the total reading hours have not exceeded the predetermined reading hours. Because the time imprinting module 356 continually updates and stores the current time in the current date information 376, users are unable to read the electrical documents for a time longer than the set period by changing the time on their own computers.

Please refer to FIG. 5 A,B, and C of a flow chart 500 of reading the electrical documents of the present invention networks 100.

Step 502: starting;

Step 504: executing the application program 352 of the terminal 106 for reading a specific electrical document(E);

Step 506: the application program 352 deciphering the ciphertext of the electrical document stored in the corresponding storing position;

Step 508: the storing position checking module 354 retrieving the storing position information (P)372 of the electrical document(E);

Step 510: the storing position checking module 354 retrieving the storing position information (Pc) of the current storing position 370;

Step 512: matching the storing position information(P)372 with the storing position information (Pc) of the current storing position 370; if yes to Step 516, if no to Step 514;

Step 514: the storing position information being changed; stopping the application program 352 and to Step 548;

Step 516: time imprinting module 356 storing the date(Dc) and the time(Tc) retrieved from the terminal 106 in the current date information 376;

Step 518: the time imprinting module 356 matching whether Dc and Tc are both earlier than the previous stored date (Dp) and the previous stored time (Tp) in the current date information(T); if yes to Step 520, if no to Step

Step 520: the date or the time of the users' own computers being changed; stopping the application program 352 and to Step 548;

Step 522: the termination date examining module 358 examining the terms of the termination date information (R) 374;

Step 524: to Step 526 if renting for a specific period of time; to Step 532 if for renting a predetermined reading hours;

Step 526: the termination date examining module 358 examining whether the termination date has arrived; if yes to step 528, if no to Step 538;

Step 528: informing users the electrical document is expired;

Step 530: stopping the application program 352 and to Step 548;

Step 532: the termination date examining module 358 examining whether the total reading hours of the electrical document exceeds the predetermined total reading hours; yes to Step 534, no to Step 538;

Step 534: informing users the electrical document is expired;

Step 536: stopping the application program 352 and to Step 548;

Step 538: the application program 352 deciphering the ciphertext of the electrical document (E)378;

Step 540: user reading the plaintext of the electrical document;

Step 542: the time imprinting module 356 continually updating and storing the current time and date in the current date information (T) 376;

Step 544: the termination date examining module 358 examining whether the termination date has arrived or whether the total reading hours has exceeded the predetermined total reading hours; if yes to Step 548, if no to Step 546;

Step 546: reading electrical document; if yes to Step 540, if no to Step 548;

Step 548: ending;

In contrast to the prior art, the advantages of the present invention networks 100 are 1) a variety of application programs 352 can be operating platforms compiled in advance and executed in different kinds of machines and operating systems, preventing electrical documents spreading illegally and not preventing the spread of the application programs 352 themselves but encouraging users to use electrical documents more often, 2) preventing the electrical document being transmitted without permission even if the electrical document is rent legally because the storing position checking module 354 retrieves the storing position of the electrical document and the storing position information of the current storing position and matches both of them to assure they are the same, 3) the storing position checking module 354 prevents the electrical document being rent legally but the plaintext about the termination date information 374 or the current time information 376 of the electrical document being changed without permission even if the ciphertext of the electrical document is hacked and the plaintext of the electrical document is changed without permission, then the storing position checking module 354 denying any further accesses to the electrical document because the storing position information of the current storing position not the same as the previous storing position information, 4) the time imprinting module 356 preventing users from gaining a longer time period for reading the electrical documents by the alteration of the time and date of their own computers because the time imprinting module 356 attaching the current time and the current date to the current date information 376, updating and storing the current time and date in the current date information every time user reading the electrical document and denying accesses to the electrical document if the current date and time of users' own computers being earlier than those of the current date information stored previously and 5) the information of the electrical document being kept private through the encryption of the information and no chance for occurrence of peeps.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method used in networks, comprising a server connected with a plurality of terminals that can request the server to rent an electrical document for a specific period of time and the server storing the electrical document to a storage device of the terminal, for controlling the termination date of electrical documents comprising the following steps:
users loading an application program in the terminal to set a specific storing position for the electrical document;
the server encrypting the current date, the termination date, and plaintext of the electrical document to a corresponding ciphertext, transferring the ciphertext to the terminal, storing the ciphertext in the specific storing position of the storage device, and recording information of the storing position when the terminal requests the server to rent the electrical document;
the application program matching whether the current storing position is the as same as the recorded storing position and deciphering the ciphertext to the original plaintext of the electrical document for users intending to read the electrical document;
the application program continually updating and storing the current date in the storing position during the time users read the electrical document; and
the application program examining whether the current date exceeds the termination date and denying access to the electrical document if the current date has exceeded the termination date.

2. The method of claim 1 wherein the information of the storing position is under encryption.

3. The method of claim 1 wherein when the terminal requests the server to rent the electrical documents for a specific period of time, the termination date is valid if the current date has not exceeded the termination date.

4. The method of claim 3 wherein the application program informs users the electrical document is expired when the current date has exceeded the termination date.

5. The method of claim 1 wherein when total reading hours exceeds a predetermined reading hours, the application program denies access to the electrical document.

6. The method of claim 5 wherein the application program informs users the electrical document is expired when the total reading hours exceeds the predetermined reading hours.

7. A network for controlling a termination date of an electrical document comprising a server connected with a plurality of terminals, each terminal comprising an application program and a storage device and the ability to request the server to rent the electrical document; the server comprising a rent control center for encrypting the current date, the termination date, and plaintext of the electrical document to a corresponding ciphertext, sending the ciphertext to the terminal, storing in a specific storing position of the storage device, and recording information of the storing position; the application program comprising:
a storing position checking module for matching whether the current storing position is the same as the recorded storing position and deciphering the ciphertext to the original plaintext of the electrical document for users intending to read the electrical document;
a time imprinting module for continually updating and storing the current date in the storing position during the time users read the electrical document; and
a termination date examining module for examining whether the current date exceeds the termination date and denying access to the electrical document if the current date exceeds the termination date.

8. The network of claim 7 wherein the information of the storing position is under encryption.

9. The method of claim 7 wherein when the terminal requests the server to rent the electrical document for a specific period of time, the termination date is valid if the current date has not exceeded the termination date.

10. The method of claim 9 wherein the application program informs users the electrical document is expired when the current date exceeds the termination date.

11. The method of claim 7 wherein when total reading hours exceeds a predetermined reading hours, the application program denies access to the electrical document.

12. The method of claim 11 wherein the application program informs users the electrical document is expired when the total reading hours exceeds the predetermined reading hours.
